(19) United States
(12) Patent Application Publication
(10) Pub. No.: US 2024/0430816 A1
(43) Pub. Date: Dec. 26, 2024

(54) TRANSMIT-POWER-AWARE RATE ADAPTATION

(71) Applicant: QUALCOMM Incorporated, San Diego, CA (US)

(72) Inventors: Kaushik BHATTACHARYA, Hyderabad (IN); Asimava BERA, Hyderabad (IN); Suman CHAKRABORTY, Hyderabad (IN); Michael Siddhartha ARPUTHARAJ, Hyderabad (IN); Venkatesh SASANAPURI, Hyderabad (IN); Narasimhamurthy VEMPATI, Hyderabad (IN)

(21) Appl. No.: 18/340,769

(22) Filed: Jun. 23, 2023

(51) Int. Cl. H04W 52/26; H04W 52/36

(52) U.S. Cl. CPC H04W 52/267; H04W 52/367

(57) ABSTRACT

Certain aspects of the present disclosure provide techniques and apparatus for transmit-power-aware rate adaptation in wireless communications. An example method of wireless communication includes determining a transmit power associated with a first signal. The method further includes determining a first information transfer rate associated with the first signal based at least in part on the determined transmit power. The method further includes transmitting the first signal at the transmit power based at least in part on the first information transfer rate.

### BACKGROUND

### Field of the Disclosure

Aspects of the present disclosure relate to wireless communications, and more particularly, to rate adaptation in wireless communications.

### Description of Related Art

Wireless communication systems are widely deployed to provide various telecommunication services such as telephony, video, data, messaging, broadcasts, etc. These wireless communications systems may employ multiple-access technologies capable of supporting communications with multiple users by sharing available wireless communications system resources with those users.

Modern wireless communication devices (such as cellular telephones) are generally mandated to meet radio frequency (RF) exposure limits set by certain governments and international standards and regulations. To ensure compliance with the standards, such devices may undergo an extensive certification process prior to being shipped to market. To ensure that a wireless communication device complies with an RF exposure limit, techniques have been developed to enable the wireless communication device to assess RF exposure from the wireless communication device and adjust the transmit power of the wireless communication device accordingly to comply with the RF exposure limit.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, such as by using rate adaptation.

### SUMMARY

Some aspects provide a method for wireless communication by a wireless device. The method includes determining a transmit power associated with a first signal. The method further includes determining a first information transfer rate associated with the first signal based at least in part on the determined transmit power. The method further includes transmitting the first signal at the transmit power based at least in part on the first information transfer rate.

Some aspects provide an apparatus for wireless communication. The apparatus includes a memory and a processor coupled to the memory. The processor is configured to determine a transmit power associated with a first signal, determine a first information transfer rate associated with the first signal based at least in part on the determined transmit power, and control transmission of the first signal at the transmit power based at least in part on the first information transfer rate.

Some aspects provide an apparatus for wireless communication. The apparatus includes means for determining a transmit power associated with a first signal. The apparatus further includes means for determining a first information transfer rate associated with the first signal based at least in part on the determined transmit power. The apparatus further includes means for transmitting the first signal at the transmit power based at least in part on the first information transfer rate.

Some aspects provide a non-transitory computer-readable medium. The computer-readable medium has instructions stored thereon, that when executed by an apparatus, cause the apparatus to perform a method. The method includes determining a transmit power associated with a first signal. The method further includes determining a first information transfer rate associated with the first signal based at least in part on the determined transmit power. The method further includes transmitting the first signal at the transmit power based at least in part on the first information transfer rate.

Other aspects provide: an apparatus operable, configured, or otherwise adapted to perform any one or more of the aforementioned methods and/or those described elsewhere herein; a non-transitory, computer-readable medium comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example wireless communication system exhibiting radio frequency (RF) exposure to a human.

FIG. 2 is a block diagram conceptually illustrating a design of an example wireless communication device communicating with another device.

FIG. 3 is a graph illustrating examples of transmit powers over time in compliance with an RF exposure limit.

FIG. 4 is a diagram illustrating an example wireless device having multiple radios.

FIG. 5 is a diagram illustrating an example logical architecture for controlling the RF exposure associated with one or more radios.

FIG. 6 is a graph of transfer rates over path loss levels illustrating example transfer rate regions.

FIG. 7 illustrates an example table mapping transfer rate configurations to various channel conditions.

FIG. 8 is a flow diagram illustrating example operations for wireless communication by a wireless device.

FIG. 9 illustrates a communications device that may include various components configured to perform operations for the techniques disclosed herein.

To facilitate understanding, identical reference numerals have been used, where possible, to designate identical elements that are common to the figures. It is contemplated that elements disclosed in one aspect may be beneficially utilized in other aspects without specific recitation.

### DETAILED DESCRIPTION

Aspects of the present disclosure provide apparatus, methods, processing systems, and computer-readable mediums for performing rate adaptation based at least in part on a transmit power.

In certain wireless communication systems (e.g., a wireless local area network (WLAN)), a wireless communication device may dynamically adjust its transfer rate in response to channel conditions. Such a process may be referred to as rate adaptation. As the wireless device performs rate adaptation, the wireless device may assess the channel conditions and adapt the transfer rate by selecting a configuration for the transmission, where the configuration may include a modulation and coding scheme (MCS), a code rate, a guard interval, and/or a channel width, for example. The wireless device may assess the channel conditions via certain channel metrics, such as packet error rate (or ratio) (PER), signal strength (e.g., received signal strength indicator (RSSI)), and/or a signal-to-noise ratio (SNR), for example.

In some cases, the wireless device may also perform certain transmit power controls (e.g., radio frequency (RF) exposure compliance, RF emission controls, RF interference controls, RF conformance control, data-rate specific power control, etc.). An adjustment in transmit power performed by the transmit power control(s) at a transmitter may affect wireless communication performance due to the transfer rate being dependent on the signal quality and/or signal strength encountered at the receiver as facilitated by the transmit power used at the transmitter. In addition, the rate adaptation performed at the transmitter may not consider or take into account the transmit power. Such an assessment of the channel conditions without being aware of the transmit power for rate adaptation may result in a delay in adjusting the transfer rate in response to changes in the transmit power, and the delay to adjust the transfer rate may result in retransmissions, increased latency, reduced throughput, and/or network congestion due to the retransmissions.

Aspects of the present disclosure provide apparatus and methods for rate adaptation based at least in part on a transmit power. In certain aspects, a wireless device may perform any of various transmit power controls that affect the output power of a radio. For example, a wireless device may perform an RF exposure evaluation to determine a transmit power in compliance with an RF exposure limit. As that transmit power may be indicative of the channel conditions and/or affect channel conditions (e.g., a lower transmit power may lead to reduced RSSI or SNR at the receiver), the wireless device may take into account the transmit power when performing rate adaptation. For example, the wireless device may determine the transfer rate based at least in part on the determined transmit power. The wireless device may select a transfer rate configuration associated with the transmit power or a parameter associated with (or affected by) the transmit power. In certain aspects, the wireless device may perform the transmit-power-aware rate adaptation, described herein, in response to one or more criteria being satisfied, such as a certain threshold associated with channel conditions being satisfied.

The apparatus and methods for transmit-power-aware rate adaptation described herein may provide various advantages. For example, the transmit-power-based rate adaptation may improve wireless communication performance, including, for example, an increased throughput, decreased latency, reduced network congestion, and/or increased transmission range, where the improved performance may be attributable to a reduced delay in adapting the transfer rate to changing channel conditions. For example, the wireless device may detect a reduction in the transmit power, for example, due to RF exposure power controls, and the wireless device may reduce the transfer rate in response to the reduction in transmit power, which may bypass the PER-based rate adaptation (or any other rate adaptation) and lead to improved wireless communication performance.

As used herein, a radio may refer to a physical or logical transmission path associated with one or more frequency bands (carriers, channels, bandwidths, subdivisions thereof, etc.), transceivers, and/or radio access technologies (RATs) (e.g., wireless wide area network (WWAN), wireless local area network (WLAN), short-range communications (Bluetooth), non-terrestrial communications, vehicle-to-everything (V2X) communications, etc.) used for wireless communications. For example, for uplink carrier aggregation (or multi-connectivity) in WWAN communications, each of the active component carriers used for wireless communications may be treated as a separate radio. Similarly, multi-band transmissions for IEEE 802.11 may be treated as separate radios for each frequency band (e.g., 2.4 GHz, 5 GHz, or 6 GHz).

### Example RF Exposure Compliance

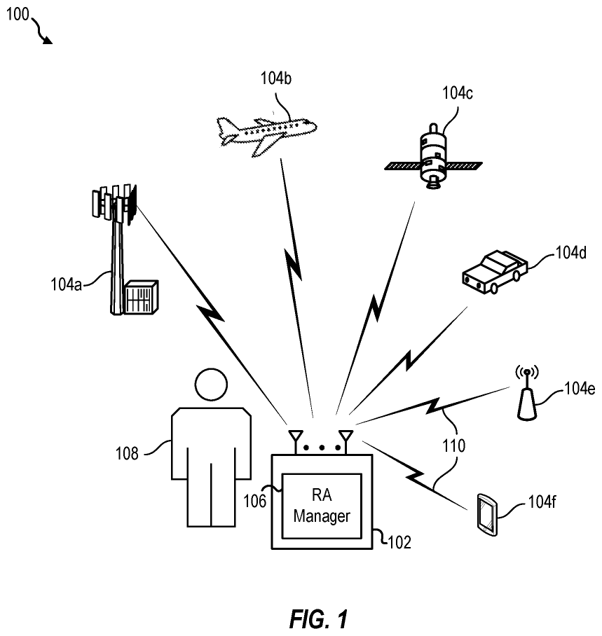

FIG. 1 illustrates an example wireless communication system 100 in which aspects of the present disclosure may be performed. For example, the wireless communication system 100 may include a wireless wide area network (WWAN) and/or a wireless local area network (WLAN). For example, a WWAN may include a New Radio system (e.g., a 5G NR network), an Evolved Universal Terrestrial Radio Access (E-UTRA) system (e.g., a 4G network), a Universal Mobile Telecommunications System (UMTS) (e.g., a 2G/3G network), a code division multiple access (CDMA) system (e.g., a 2G/3G network), any future WWAN system, or any combination thereof. A WLAN may include a wireless network configured for communications according to an IEEE standard such as one or more of the 802.11 standards, etc. In some cases, the wireless communication system 100 may include a device-to-device (D2D) communications network or a short-range communications system, such as Bluetooth communications.

As illustrated in FIG. 1, the wireless communication system 100 may include a first wireless device 102 communicating with any of various second wireless devices 104a-f (a second wireless device 104) via any of various radio access technologies (RATs), where a wireless device may refer to a wireless communication device. The RATs may include, for example, WWAN communications (e.g., E-UTRA and/or 5G NR), WLAN communications (e.g., IEEE 802.11), vehicle-to-everything (V2X) communications, non-terrestrial network (NTN) communications, short-range communications (e.g., Bluetooth), etc.

The first wireless device 102 may be emitting RF signals in proximity to a human 108, who may be the user of the first wireless device 102 and/or a bystander. As an example, the first wireless device 102 may be held in the hand of the human 108 and/or positioned against or near the head of the human 108. In certain cases, the first wireless device 102 may be positioned in a pocket or bag of the human 108. In some cases, the first wireless device 102 may be positioned proximate to the human 108 as a mobile hotspot. To ensure the human 108 is not overexposed to RF emissions from the first wireless device 102, the first wireless device 102 may control the transmit power associated with the RF signals in accordance with an RF exposure limit, as further described herein, where the RF exposure limit may depend on corresponding exposure scenario (e.g., head exposure, extremity (e.g., hand) exposure, body (e.g., body-worn) exposure, hotspot exposure, etc.). Extremities may include, for example, hands, wrists, feet, ankles, and pinnae.

The first wireless device 102 may include any of various wireless communication devices including a user equipment (UE), a wireless station, an access point, a customer-premises equipment (CPE), etc. In certain aspects, the first wireless device 102 includes a rate adaptation (RA) manager 106 that determines a transfer rate based at least in part on a transmit power, in accordance with aspects of the present disclosure.

The second wireless devices 104a-f may include, for example, a base station 104a, an aircraft 104b, a satellite 104c, a vehicle 104d, an access point (AP) 104e, and/or a UE 104f. Further, the wireless communication system 100 may include terrestrial aspects, such as ground-based network entities (e.g., the base station 104a and/or access point 104e), and/or non-terrestrial aspects, such as the aircraft 104b and the satellite 104c, which may include network entities on-board (e.g., one or more base stations) capable of communicating with other network elements (e.g., terrestrial base stations) and/or user equipment.

The base station 104a may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. The base station 104a may provide communications coverage for a respective geographic coverage area, which may sometimes be referred to as a cell, and which may overlap in some cases (e.g., a small cell may have a coverage area that overlaps the coverage area of a macro cell). A base station may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

The first wireless device 102 and/or the UE 104f may generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. A UE may also be referred to more generally as a mobile device, a wireless device, a wireless communications device, a wireless station (STA), a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and other terms.

According to some aspects, the wireless communication system 100 can include a WLAN, such as a Wi-Fi network. For example, the wireless communication system 100 can be a network implementing at least one of the IEEE 802.11 family of wireless communication protocol standards (such as that defined by the IEEE 802.11-2020 specification or amendments thereof including, but not limited to, 802.11ay, 802.11ax, 802.11az, 802.11ba, 802.11bd, 802.11be, 802.11bf, and the 802.11 amendment associated with Wi-Fi 8). The wireless communication system 100 may include numerous wireless communication devices such as wireless AP(s) and STAs. For example, the first wireless device 102, the second wireless device 104, and the UE 104f may be representative of an AP and/or STA. As an example, in some cases, the first wireless device 102 may operate as an AP and/or a STA. The wireless communication system 100 can include multiple APs, including the AP 104c and/or the first wireless device 102. The AP can represent various different types of APs including but not limited to enterprise-level APs, single-frequency APs, dual-band APs, standalone APs, software-enabled APs (soft APs), and multi-link APs. The coverage area and capacity of a cellular network (such as E-UTRA, 5G NR, etc.) can be further improved by a small cell which is supported by an AP serving as a miniature base station. Furthermore, private cellular networks also can be set up through a wireless area network using small cells.

A single AP and an associated set of STAs may be referred to as a basic service set (BSS), which is managed by the respective AP. The coverage area of the AP may represent a basic service area (BSA) of the wireless communication system 100. The BSS may be identified or indicated to users by a service set identifier (SSID), as well as to other devices by a basic service set identifier (BSSID), which may be a medium access control (MAC) address of the AP. The AP may periodically broadcast beacon frames (“beacons”) including the BSSID to enable any STAs within wireless range of the AP to “associate” or re-associate with the AP to establish a respective communication link 110, or to maintain a communication link 110, with the AP. For example, the beacons can include an identification or indication of a primary channel used by the respective AP as well as a timing synchronization function for establishing or maintaining timing synchronization with the AP. The AP may provide access to external networks to various STAs in the WLAN via respective communication links 110.

To establish a communication link 110 with an AP, each of the STAs is configured to perform passive or active scanning operations (“scans”) on frequency channels in one or more frequency bands (for example, the 2.4 GHz, 5 GHz, 6 GHz, or 60 GHz bands). To perform passive scanning, a STA listens for beacons, which are transmitted by respective APs at a periodic time interval referred to as the target beacon transmission time (TBTT) (measured in time units (TUs) where one TU may be equal to 1024 microseconds (us)). To perform active scanning, a STA generates and sequentially transmits probe requests on each channel to be scanned and listens for probe responses from APs. Each STA may identify, determine, ascertain, or select an AP with which to associate in accordance with the scanning information obtained through the passive or active scans, and to perform authentication and association operations to establish a communication link 110 with the selected AP. The AP assigns an association identifier (AID) to the STA at the culmination of the association operations, which the AP uses to track the STA.

As a result of the increasing ubiquity of wireless networks, a STA may have the opportunity to select one of many BSSs within range of the STA or to select among multiple APs that together form an extended service set (ESS) including multiple connected BSSs. An extended network station associated with the wireless communication system 100 may be connected to a wired or wireless distribution system that may allow multiple APs to be connected in such an ESS. As such, a STA can be covered by more than one AP and can associate with different APs at different times for different transmissions. Additionally, after association with an AP, a STA also may periodically scan its surroundings to find a more suitable AP with which to associate. For example, a STA that is moving relative to its associated AP may perform a “roaming” scan to find another AP having more desirable network characteristics such as a greater received signal strength indicator (RSSI) or a reduced traffic load.

In some cases, STAs may form networks without APs or other equipment other than the STAs themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the wireless communication system 100. In such examples, while the STAs may be capable of communicating with each other through the AP using communication links 110, STAs also can communicate directly with each other via direct wireless communication links 110. For example, the first wireless device 102 may communicate directly with the UE 104f via WLAN communications (or other P2P communications, e.g., Bluetooth). Additionally, two STAs may communicate via a direct communication link 110 regardless of whether both STAs are associated with and served by the same AP. In such an ad hoc system, one or more of the STAs may assume the role filled by the AP in a BSS. Such a STA may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections. In some cases, the first wireless device 102 may be capable of communicating with multiple peers including STA(s) and/or AP(s).

The APs and STAs may function and communicate (via the respective communication links 110) according to one or more of the IEEE 802.11 family of wireless communication protocol standards. These standards define the WLAN radio and baseband protocols for the physical (PHY) and medium access control (MAC) layers. The APs and STAs transmit and receive wireless communications (hereinafter also referred to as “wireless packets”) to and from one another in the form of PHY protocol data units (PPDUs). The APs and STAs in the wireless communication system 100 may transmit PPDUs over an unlicensed or shared spectrum, which may be a portion of spectrum that includes frequency bands used by WLAN technology, such as the 2.4 GHz band, the 5 GHz band, the 60 GHz band, the 3.6 GHz band, and the 900 MHz band. Some examples of the APs and STAs described herein also may communicate in other frequency bands, such as the 5.9 GHz and the 6 GHz bands, which may support both licensed and unlicensed communications. The APs and STAs also can communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4 GHz, 5 GHz or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload.

In certain wireless communication systems (e.g., a WLAN), a wireless device may perform rate adaptation to adjust the device's transfer rate in response to channel conditions. As the capacity of the channel depends on the channels conditions, the wireless device may assess the channel conditions and determine a suitable transfer rate based on the channel conditions. For example, the wireless device may assess the channel conditions via any of various channel metrics or properties, including, for example, a channel quality indicator, a signal-to-noise ratio (SNR), a signal-to-interference-plus-noise ratio (SINR), a signal-to-noise-plus-distortion ratio (SNDR), a received signal strength indicator (RSSI), a reference signal received power (RSRP), a reference signal received quality (RSRQ), a data error rate or ratio (e.g., a packet error (PER)), and/or a metric derived from any of thereof (e.g., a time-averaged value, a filtered value, a weighted combination, etc.). The wireless device may identify a transfer rate configuration that corresponds to the channel conditions.

The transfer rate configuration may include any of various parameters, such as the number of spatial streams in a transmission, a modulation and coding scheme (MCS), a code rate, a guard interval, and/or a channel width. It will be appreciated that these parameters for the transfer rate configuration are an example of the parameters that could be used. In other RATs (e.g., WWAN communications or future RATs), the transfer rate may depend on other parameter(s) in addition to or instead of those described herein with respect to WLAN communications, such as duplexing mode (frequency or time), the number of aggregated carriers, the number of multiple-input multiple-output (MIMO) layers, the bandwidth, the subcarrier spacing, the frequency range (e.g., Frequency Range-1 (FR1) or Frequency Range-2 (FR2)).

In certain cases, the first wireless device 102 may control the transmit power used to emit RF signals in compliance with an RF exposure limit. RF exposure may be expressed in terms of a specific absorption rate (SAR), which measures energy absorption by human tissue per unit mass and may have units of watts per kilogram (W/kg). RF exposure may also be expressed in terms of power density (PD), which measures energy absorption per unit area and may have units of milliwatts per square centimeter (mW/cm²). In some cases, the RF exposure may be expressed in terms of a specific energy absorption (SA) limit or an absorbed energy density (Uab) limit, for example, for a total RF energy limit allowed in a specific time period. In certain cases, a maximum permissible exposure (MPE) limit in terms of PD may be imposed for wireless communication devices using transmission frequencies above 6 GHz. Frequency bands of 24 GHz to 71 GHz or greater are sometimes referred to as a “millimeter wave” (“mmW” or “mmWave”). The MPE limit is a regulatory metric for exposure based on area, e.g., an energy density limit defined as a number, X, watts per square meter (W/m²) averaged over a defined area and time-averaged over a frequency-dependent time window in order to prevent a human exposure hazard represented by a tissue temperature change. Certain RF exposure limits may be specified based on a maximum RF exposure metric (e.g., SAR or PD) averaged over a specified time window (e.g., 100 or 360 seconds for sub-6 GHz frequency bands or 2 seconds for 60 GHz bands).

SAR may be used to assess RF exposure for transmission frequencies less than 6 GHz, which cover wireless communication technologies such as 2G/3G (e.g., CDMA), 4G (e.g., E-UTRA), 5G (e.g., NR in sub-6 GHz bands), IEEE 802.11 (e.g., a/b/g/n/ac), etc. PD may be used to assess RF exposure for transmission frequencies higher than 6 GHz, which cover wireless communication technologies such as IEEE 802.11ad. 802.11ay, 5G in mmWave bands, etc. Thus, different metrics may be used to assess RF exposure for different wireless communication technologies.

A wireless device (e.g., the first wireless device 102) may be capable of transmitting signals using multiple wireless communication technologies and/or frequency bands, and in some cases, capable of simultaneous transmission of such signals. For example, the wireless device may transmit signals using a first wireless communication technology operating at or below 6 GHz (e.g., 3G, 4G, 5G, 802.11a/b/g/n/ac, etc.) and a second wireless communication technology operating above 6 GHz (e.g., mm Wave 5G in 24 to 60 GHz bands, IEEE 802.11ad or 802.11ay). In certain aspects, the wireless device may transmit signals using the first wireless communication technology (e.g., 3G, 4G, 5G in sub-6 GHz bands, IEEE 802.11ac, etc.) in which RF exposure may be measured in terms of SAR, and the second wireless communication technology (e.g., 5G in 24 to 71 GHz bands, IEEE 802.11ad, 802.11ay, etc.) in which RF exposure may be measured in terms of PD.

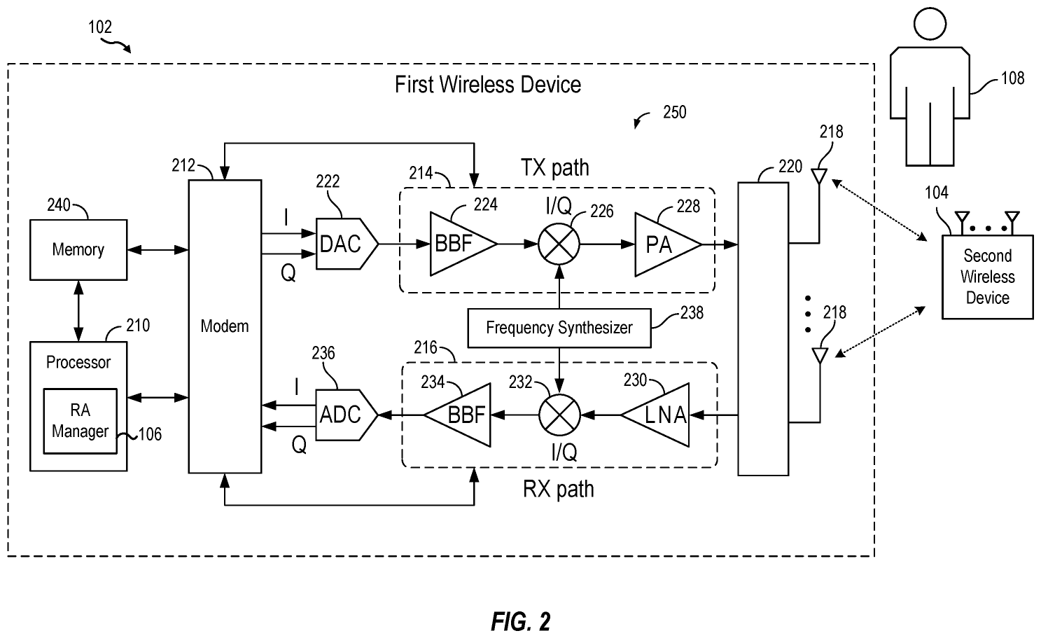

FIG. 2 illustrates example components of the first wireless device 102, which may be used to communicate with any of the second wireless devices 104, in some cases, in proximity to human tissue as represented by the human 108.

The first wireless device 102 may be, or may include, a chip, system on chip (SoC), chipset, package or device that includes one or more modems 212. In some cases, the modem(s) 212 may include, for example, any of a WWAN modem (e.g., a modem configured to communicate via E-UTRA and/or 5G NR standards), a WLAN modem (e.g., a modem configured to communicate via 802.11 standards), a Bluetooth modem, a NTN modem, etc. In certain aspects, the first wireless device 102 also includes one or more radios (collectively “the radio 250”). In some aspects, the first wireless device 102 further includes one or more processors, processing blocks or processing elements (collectively “the processor 210”) and one or more memory blocks or elements (collectively “the memory 240”).

In certain aspects, the processor 210 may include a processor representative of an application processor that generates information (e.g., application data such as content requests) for transmission and/or receives information (e.g., requested content) via the modem 212. In some cases, the processor 210 may include a microprocessor associated with the modem 212, which may implement the rate adaptation manager 106 and/or process any of certain protocol stack layers associated with a radio access technology (RAT). For example, the processor 210 may process any of an application layer, packet layer, WLAN protocol stack layers (e.g., a link or medium access control (MAC) layer), and/or WWAN protocol stack layers (e.g., a radio resource control (RRC) layer, a packet data convergence protocol (PDCP) layer, a radio link control (RLC) layer, and a MAC layer). In some cases, at least one of the modems 212 (e.g., the WWAN modem) may be in communication with one or more of the other modems 212 (e.g., the WLAN modem and/or Bluetooth modem). For example, the processor 210 may be representative of at least one of the modems 212 in communication with one or more of the other modems 212.

The modem 212 may include an intelligent hardware block or device such as, for example, an application-specific integrated circuit (ASIC) among other possibilities. The modem 212 may generally be configured to implement a physical (PHY) layer. For example, the modem 212 may be configured to modulate packets and to output the modulated packets to the radio 250 for transmission over a wireless medium. The modem 212 is similarly configured to obtain modulated packets received by the radio 250 and to demodulate the packets to provide demodulated packets. In addition to a modulator and a demodulator, the modem 212 may further include digital signal processing (DSP) circuitry, automatic gain control (AGC), a coder, a decoder, a multiplexer and a demultiplexer (not shown).

As an example, while in a transmission mode, the modem 212 may obtain data from the processor 210. The data obtained from the processor 210 may be provided to a coder, which encodes the data to provide encoded bits. The encoded bits may be mapped to points in a modulation constellation (e.g., using a selected modulation and coding scheme) to provide modulated symbols. The modulated symbols may be mapped, for example, to spatial stream(s) or space-time streams. The modulated symbols may be multiplexed, transformed via an inverse fast Fourier transform (IFFT) block, and subsequently provided to DSP circuitry for transmit windowing and filtering. The digital signals may be provided to a digital-to-analog converter (DAC) 222. In certain aspects involving beamforming, the modulated symbols in the respective spatial streams may be precoded via a steering matrix prior to provision to the IFFT block.

The modem 212 may be coupled to the radio 250 including a transmit (TX) path 214 (also known as a transmit chain) for transmitting signals via one or more antennas 218 and a receive (RX) path 216 (also known as a receive chain) for receiving signals via the antennas 218. When the TX path 214 and the RX path 216 share an antenna 218, the paths may be connected with the antenna via an interface 220, which may include any of various suitable RF devices, such as a switch, a duplexer, a diplexer, a multiplexer, and the like. As an example, the modem 212 may output digital in-phase (I) and/or quadrature (Q) baseband signals representative of the respective symbols to the DAC 222.

Receiving I or Q baseband analog signals from the DAC 222, the TX path 214 may include a baseband filter (BBF) 224, a mixer 226 (which may include one or several mixers), and a power amplifier (PA) 228. The BBF 224 filters the baseband signals received from the DAC 222, and the mixer 226 mixes the filtered baseband signals with a transmit local oscillator (LO) signal to convert the baseband signal to a different frequency (e.g., upconvert from baseband to a radio frequency). In some aspects, the frequency conversion process produces the sum and difference frequencies between the LO frequency and the frequencies of the baseband signal. The sum and difference frequencies are referred to as the beat frequencies. Some beat frequencies are in the RF range, such that the signals output by the mixer 314 are typically RF signals, which may be amplified by the PA 228 before transmission by the antenna 218. The antennas 218 may emit RF signals, which may be received at the second wireless device 104. While one mixer 226 is illustrated, several mixers may be used to upconvert the filtered baseband signals to one or more intermediate frequencies and to thereafter upconvert the intermediate frequency signals to a frequency for transmission.

The RX path 216 may include a low noise amplifier (LNA) 230, a mixer 232 (which may include one or several mixers), and a baseband filter (BBF) 234. RF signals received via the antenna 218 (e.g., from the second wireless device 104) may be amplified by the LNA 230, and the mixer 232 mixes the amplified RF signals with a receive local oscillator (LO) signal to convert the RF signal to a baseband frequency (e.g., downconvert). The baseband signals output by the mixer 232 may be filtered by the BBF 234 before being converted by an analog-to-digital converter (ADC) 236 to digital I or Q signals for digital signal processing. The modem 212 may receive the digital I or Q signals and further process the digital signals, for example, demodulating the digital signals.

Certain transceivers may employ frequency synthesizers with a voltage-controlled oscillator (VCO) to generate a stable, tunable LO frequency with a particular tuning range. Thus, the transmit LO frequency may be produced by a frequency synthesizer 238, which may be buffered or amplified by an amplifier (not shown) before being mixed with the baseband signals in the mixer 226. Similarly, the receive LO frequency may be produced by the frequency synthesizer 238, which may be buffered or amplified by an amplifier (not shown) before being mixed with the RF signals in the mixer 232. Separate frequency synthesizers may be used for the TX path 214 and the RX path 216.

While in a reception mode, the modem 212 may obtain digitally converted signals via the ADC 236 and RX path 216. As an example, in the modem 212, digital signals may be provided to the DSP circuitry, which is configured to acquire a received signal, for example, by detecting the presence of the signal and estimating the initial timing and frequency offsets. The DSP circuitry is further configured to digitally condition the digital signals, for example, using channel (narrowband) filtering, analog impairment conditioning (such as correcting for I/Q imbalance), and applying digital gain to ultimately obtain a narrowband signal. The output of the DSP circuitry may be fed to the AGC, which is configured to use information extracted from the digital signals, for example, in one or more received training fields, to determine an appropriate gain. The output of the DSP circuitry also may be coupled with the demodulator, which is configured to extract modulated symbols from the signal and, for example, compute the logarithm likelihood ratios (LLRs) for each bit position of each subcarrier in each spatial stream. The demodulator may be coupled with the decoder, which may be configured to process the LLRs to provide decoded bits. The decoded bits from all of the spatial streams may be fed to the demultiplexer for demultiplexing. The demultiplexed bits may be descrambled and provided to a medium access control layer (e.g., the processor 210) for processing, evaluation, or interpretation.

The processor 210 and/or modem 212 may control the transmission of signals via the TX path 214 and/or reception of signals via the RX path 216. In some aspects, the processor 210 and/or modem 212 may be configured to perform various operations, such as those associated with any of the methods described herein. The processor 210 and/or the modem 212 may include a microcontroller, a microprocessor, an application processor, a baseband processor, a MAC processor, a neural network processor, a digital signal processor (DSP), an application specific integrated circuit (ASIC), a field programmable gate array (FPGA) or other programmable logic device (PLD), discrete gate or transistor logic, discrete hardware components, or any combination thereof. In some cases, aspects of the processor 210 may be integrated with (incorporated in and/or shared with) the modem 212, such as the RA manager 106, a microcontroller, a microprocessor, a baseband processor, a medium access control (MAC) processor, a digital signal processor, etc. For example, the processor 210 may be representative of one or more co-processors (e.g., one or more microprocessors) associated with the modem 212, and the modem 212 may be representative of one or more ASICs including the baseband processor, MAC processor, DSP, and/or neural network processor. The memory 240 may store data and program codes (e.g., computer-readable instructions) for performing wireless communications as described herein. The memory 240 may be external to the processor 210 and/or the modem 212 (as illustrated) and/or incorporated therein. In certain cases, the processor 210 and/or the modem 212 may determine a transmit power (e.g., corresponding to certain levels of gain(s) applied to the TX path 214 including the BBF 224, the mixer 226, and/or the PA 228) that complies with an RF exposure limit set by country-specific regulations and/or international guidelines (e.g., International Commission on Non-Ionizing Radiation Protection (ICNIRP) guidelines) as described herein.

FIG. 2 shows an example transceiver design. It will be appreciated that other transceiver designs or architectures may be applied in connection with aspects of the present disclosure. For example, while examples discussed herein utilize I and Q signals (e.g., quadrature modulation), those of skill in the art will understand that components of the transceiver may be configured to utilize any other suitable modulation, such as polar modulation. As another example, circuit blocks may be arranged differently from the configuration shown in FIG. 2, and/or other circuit blocks not shown in FIG. 2 may be implemented in addition to or instead of the blocks depicted.

In certain cases, compliance with an RF exposure limit may be performed as a time-averaged RF exposure evaluation within a specified running (moving) time window associated with the RF exposure limit. The RF exposure limit may specify a time-averaged RF exposure metric (e.g., SAR and/or PD) over the running time window. As an example, the Federal Communications Commission (FCC) specifies that certain SAR limits (general public exposure) are 0.08 W/kg, as averaged over the whole body, and a peak spatial-average SAR of 1.6 W/kg, averaged over any 1 gram of tissue (defined as a tissue volume in the shape of a cube) for sub-6 GHz bands, whereas certain PD limits are 1 mW/cm², as averaged over the whole body, and a peak spatial-average PD of 4 mW/cm², averaged over any 1 cm². The FCC also specifies the corresponding averaging time may be six minutes (360 seconds) for sub-6 GHz bands, whereas the averaging time may be 2 seconds for mmWave bands (e.g., 60 GHz frequency bands) under a proposed regulation, for example.

The RF exposure limit and/or corresponding averaging time window may vary based on the frequency band. In certain aspects, the RF exposure limit(s) and/or corresponding averaging time window(s), if applicable, may be specific to a particular geographic region or country, such as the United States, Canada, China, or European Union. In some cases, the RF exposure limit(s) may specify the maximum allowed RF exposure that can be encountered without time averaging. In such cases, the maximum allowed RF exposure may correspond to a maximum output or transmit power that can be used by the wireless device.

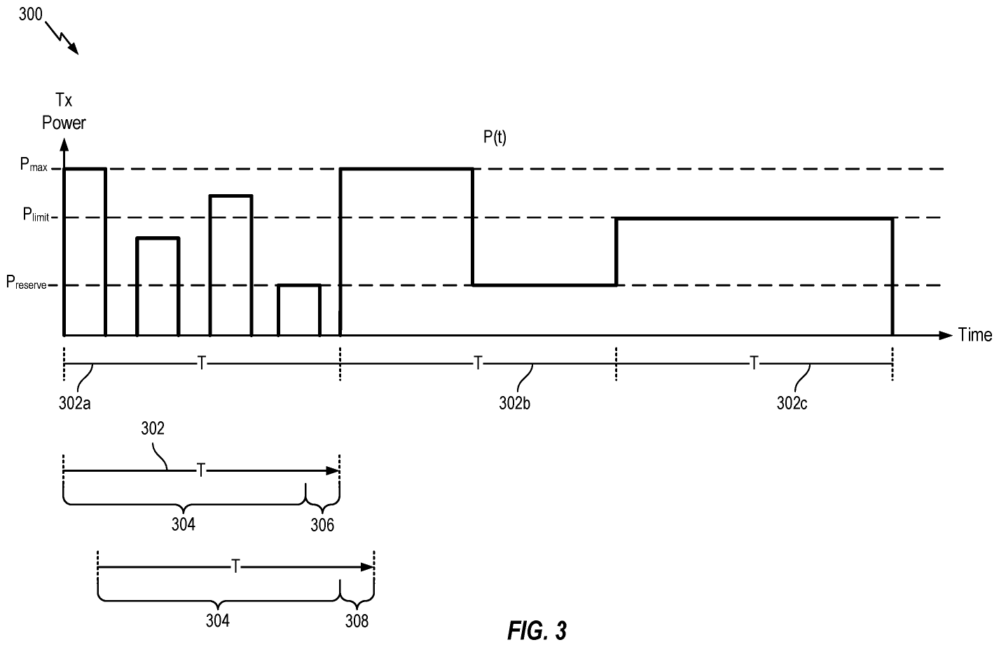

FIG. 3 is a graph 300 of a transmit power over time (P(t)) that varies over a running (e.g., rolling or moving) time window (T) associated with the RF exposure limit. The wireless device (e.g., the first wireless device 102) may evaluate RF exposure compliance over the running time window 302 (T) based on past RF exposure (e.g., a transmit power report) in a past time interval 304 of the time window 302 and a future time interval 306. The wireless device may determine the maximum allowed transmit power for the future time interval 306 that satisfies the time-averaged RF exposure limit based on the past RF exposure used in the past time interval 304. The wireless device may perform such a time-averaging evaluation as the time window 302 moves over time, for example, in the next future time interval 308, where the past time interval 304 now includes the previous future time interval 306.

The maximum time-averaged transmit power limit (Pₗᵢₘᵢₜ) represents the maximum transmit power the wireless device can transmit continuously for the duration of the running time window 302 (T) in compliance with the RF exposure limit. For example, the wireless device is transmitting continuously at Pₗᵢₘᵢₜ in the third time window 302c such that the time-averaged transmit power over the time window (e.g., the third time window 302c) is equal to Pₗᵢₘᵢₜ in compliance with the time-averaged RF exposure limit.

In certain cases, an instantaneous transmit power may exceed Pₗᵢₘᵢₜ in certain transmission occasions, for example, as shown in the first time window 302a and the second time window 302b. In some cases, the wireless device may transmit at Pₘₐₓ, which may be the maximum instantaneous transmit power supported by the wireless device, the maximum instantaneous transmit power the wireless device is capable of outputting, or the maximum instantaneous transmit power allowed by a standard or regulatory body (e.g., the maximum output power, P_{CMAX}). In some cases, the wireless device may transmit at a transmit power less than or equal to Pₗᵢₘᵢₜ in certain transmission occasions, for example, as shown in the first time window 302a.

In certain cases, a reserve power may be used to enable a continuous transmission within a time window (T) when transmitting above Pₗᵢₘᵢₜ in the time window or to enable a certain level of quality for certain transmissions. As shown in the second time window 302b, the transmit power may be backed off from Pₘₐₓ to a reserve power (Preserve) so that the wireless device can maintain a continuous transmission during the time window (e.g., maintain a radio connection with a receiving entity) in compliance with the time-averaged RF exposure limit. In the third time window 302c, the wireless device may increase the transmit power to Pₗᵢₘᵢₜ in compliance with the time-averaged RF exposure limit. In some cases, Pᵣₑₛₑᵣᵥₑ may allow for a certain level of transmission quality for certain transmissions (e.g., control signaling, high priority communications, low latency communications, highly reliable communications, etc.). Pᵣₑₛₑᵣᵥₑ may be used to reserve transmit power for at least a portion of the time window 302 for certain transmissions (e.g., control signaling).

In the second time window 302b, the area between Pₘₐₓ and Pᵣₑₛₑᵣᵥₑ for the time duration of transmitting at Pₘₐₓ may be equal to the area between Pₗᵢₘᵢₜ and Pᵣₑₛₑᵣᵥₑ for the time window T, such that the total area of transmit power (P(t)) in the second time window 302b is equal to the area of Pₗᵢₘᵢₜ for the time window T. Such an area may be considered using 100% of the energy (transmit power or exposure) to remain compliant with the time-averaged RF exposure limit. Without the reserve power Pᵣₑₛₑᵣᵥₑ, the transmitter may transmit at Pₘₐₓ for a portion of the time window with the transmitter turned off for the remainder of the time window to ensure compliance with the time-averaged RF exposure limit.

In some aspects, the wireless device may transmit at a power that is higher than Pₗᵢₘᵢₜ, but less than Pₘₐₓ in the time-average mode illustrated in the second time window 302b. While a single transmit burst is illustrated in the second time window 302b, it will be understood that the wireless device may instead utilize a plurality of transmit bursts within the time window (T), where the transmit bursts are separated by periods during which the transmit power is maintained at or below Pᵣₑₛₑᵣᵥₑ. Further, it will be understood that the transmit power of each transmit burst may vary (either within the burst and/or in comparison to other bursts), and that at least a portion of the burst may be transmitted at a power above Pₗᵢₘᵢₜ.

In certain aspects, the wireless device may transmit at a power less than or equal to a fixed power limit (e.g., Pₗᵢₘᵢₜ) without considering past exposure and/or past transmit powers in terms of a time-averaged RF exposure. For example, the wireless device may transmit at a power less than or equal to Pₗᵢₘᵢₜ using a look-up table (comprising one or more values of Pₗᵢₘᵢₜ depending on an RF exposure scenario). The look-up table may provide one or more values of Pₗᵢₘᵢₜ depending on the transmit frequency, transmit antenna, radio configuration (single-radio or multi-radio) and/or RF exposure scenario (e.g., a device state index corresponding to head exposure, body or torso exposure, extremity or hand exposure, and/or hotspot exposure) encountered by the wireless device. Examples of RF exposure scenarios include cases where the wireless device is emitting RF signals proximate to human tissue, such as a user's head, hand, or body (e.g., torso), or where the wireless device is being used as a hotspot away from human tissue. Therefore, the RF exposure can be managed as a time-averaged RF exposure evaluation (e.g., illustrated in FIG. 3), managed using a look-up table or flat or maximum value, or using another strategy or algorithm, where a particular process of managing the RF exposure may be referred to herein as an RF exposure control scheme.

For certain aspects, a wireless device may exhibit or be configured with a transmission duty cycle. The wireless device may determine transmit power level(s) and/or reserve power level(s) in compliance with the time-averaged RF exposure limit based on the duty cycle. The transmission duty cycle may be indicative of a share (e.g., 100 ms) of a specific period (e.g., 500 ms) in which the wireless device transmits RF signals. The duty cycle may be a ratio of the share to the specific period (e.g., 100 ms/500 ms), where the duty cycle may be represented as a number from zero to one. The duty cycle may be an effective duty cycle associated with a total transmit time of one or more transmissions in the time period, where the one or more transmissions may include bursts of transmissions having a gap of time positioned between at least two of the bursts. For example, in the first time window 302a, the duty cycle may be greater than 50% of the duration of the time window (T), whereas in the second time window 302b, the duty cycle may be equal to 100% of the duration of the time window (T). In certain cases, the duty cycle may be standardized (e.g., predetermined) with a specific RAT and/or vary over time, for example, due to changes in radio conditions, mobility, and/or user behavior.

As an example, certain RATs may specify the uplink duty cycle in the form of a time division duplexing (TDD) configuration, such as a TDD uplink-downlink (UL-DL) slot pattern in 5G NR or similar TDD patterns in E-UTRA or UMTS. In 5G NR, the TDD UL-DL slot pattern may specify the number of uplink slots and corresponding position in time associated with the uplink slots in a sequence of slots, such that the total number of uplink slots with respect to the total number of slots in the sequence is indicative of the duty cycle. In certain aspects, the duty cycle may correspond to the actual duration for past transmissions scheduled or used, for example, within the TDD UL-DL slot pattern. For example, although the wireless device may be configured with a TDD UL-DL slot pattern, the wireless device may use a portion or subset of the UL slots for transmitting RF signals. Thus, the duty cycle for the wireless device may be less than the maximum available duty cycle corresponding to the TDD UL-DL slot pattern.

When certain transmit power controls (e.g., RF exposure compliance, RF emissions, RF interference, RF conformance control, data rate specific power control, RF saturation, etc.) adjust the transmit power of a transmission from a wireless device (e.g., the first wireless device 102), such adjustments in the transmit power can impact the channel capacity of the communication link between the wireless device and another wireless device (e.g., the second wireless device 104). A variation in the transmit power used at the transmitter may affect the quality or strength of the signal received at the receiver (e.g., increasing or decreasing the SNR, RSSI, PER, etc.). In some cases, the resulting received signal strength may go above and below a sensitivity of a transfer rate at the receiver. For example, suppose a transfer rate can be achieved at a range of RSSIs, if an adjustment to the transmit power at the transmitter (for example, implemented due to any of various transmit power controls) causes the RSSI to go outside the range of RSSIs, the wireless device may encounter a reduced throughput due to transmission errors and/or retransmissions to compensate for the mismatch in RSSI and transfer rate. As an example, the wireless device may use a lower transfer rate despite the RSSI being able to support a higher transfer rate. In some cases, the PER may increase as transmit power controls adjust the transmit power.

The rate adaptation performed at the transmitting device may adjust the transfer rate in response to changes in channel conditions, for example, as indicated by PER. SNR. RSSI, etc. The rate adaptation may not consider or take into account the transmit power being adjusted by certain transmit power controls. Such an assessment of the channel conditions, without the transmit power, for rate adaptation may result in a delay in adjusting the transfer rate in response to changes in the transmit power, and the delay to adjust the transfer rate may result in retransmissions, increased latency, reduced throughput, and/or network congestion due to the retransmissions.

### Example Transmit-Power-Aware Rate Adaption

Aspects of the present disclosure provide apparatus and methods for rate adaptation based at least in part on a transmit power. In certain aspects, a wireless device may perform any of various transmit power controls that affect the output power of a radio. For example, a wireless device may perform an exposure evaluation to determine a transmit power in compliance with an RF exposure limit, as described herein with respect to FIG. 3, for example. As that transmit power may be indicative of the channel conditions or affect channel conditions (e.g., a lower transmit power at the transmitter may lead to reduced RSSI or SNR at the receiver), the wireless device may take into account or consider the transmit power when performing rate adaptation. For example, the wireless device may determine the transfer rate based at least in part on the determined transmit power. In some cases, the wireless device may access a table mapping transfer rate configurations (including, for example, an MCS, a code rate, a guard interval, a channel width, or any combination thereof) to transmit powers or parameters associated with (affected by) the transmit power. The wireless device may select the transfer rate configuration associated with the transmit power or parameter per the mapping in the table. In certain aspects, the wireless device may perform the transmit-power-aware rate adaptation, described herein, in response to one or more criteria being satisfied, such as a certain threshold associated with channel conditions being satisfied. For example, the wireless device may perform the transmit-power-aware rate adaptation when the RSSI goes below a threshold, or the PER goes above a threshold.

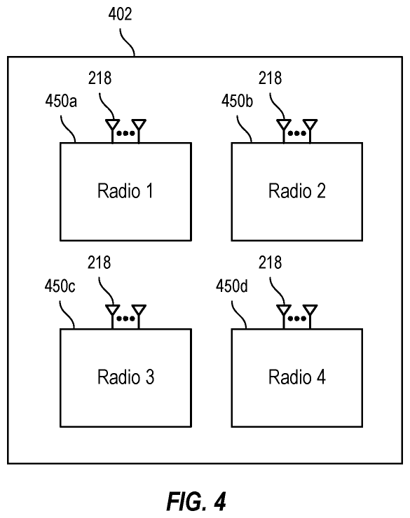

FIG. 4 is a diagram illustrating an example wireless device 402 (e.g., the first wireless device 102) having multiple radios 450a-d (e.g., the radios 250). In this example, the radios 450a-d may be associated with any of various RATs and/or frequency bands, channels, bandwidths, carriers, etc. For example, the first radio 450a may communicate via WWAN RAT(s) (e.g., E-UTRA and/or 5G NR) in sub-6 GHz frequency bands. The second radio 450b may communicate via WWAN RAT(s) (e.g., 5G NR) in mmWave frequency bands. The third radio 450c may communicate via WLAN RAT(s) in sub-6 GHz (e.g., 2.4 GHz, 5 GHz, and/or 6 GHz) frequency bands. The fourth radio 450d may communicate via short-range communications (e.g., Bluetooth) in a 2.4 GHz frequency band. While this example shows a wireless device having four radios, a wireless device may have any number of radios for wireless communications, such as a radio per frequency band associated with WWAN and/or WLAN communications, a radio per RAT, and/or a radio capable of communicating via multiple RATs.

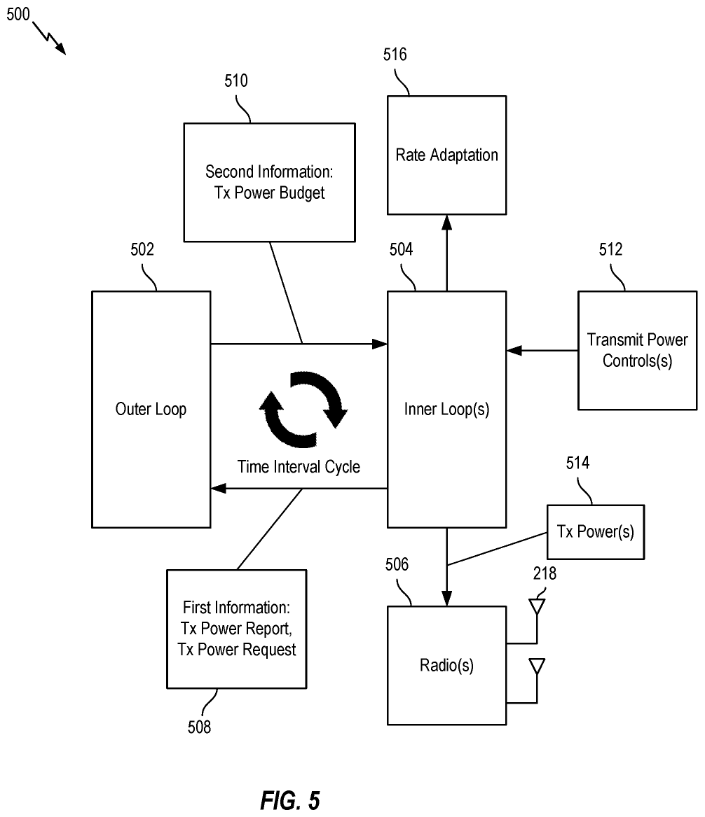

FIG. 5 is a diagram illustrating an example logical architecture 500 for controlling the transmit power (and hence, the RF exposure, RF emissions, RF interference, etc.) associated with one or more radios 506 (e.g., the radio(s) 450a-d) of a wireless device (e.g., the wireless device 402). As the outer loop 502 and the inner loop(s) 504 control transmit power(s) applied at the radio(s) 506 to be in compliance with an RF exposure limit, aspects of the outer loop 502 and/or the inner loop(s) 504 may be representative of the RF exposure manager 106. In certain aspects, the outer loop 502 may be representative of a centralized RF exposure manager, and the inner loop(s) 504 may be representative of transmit power manager(s) associated with the radio(s) 506, as further described herein. As an example, the outer loop 502 may be implemented in a WWAN modem, and at least one of the inner loops 504 may be implemented in a WLAN modem or a multi-RAT modem (e.g., a modem configured to perform WLAN and Bluetooth communications). With respect to FIG. 2, the outer loop 502 may be implemented in the processor 210 (which as described herein may include or be representative of, in some cases, a modem—e.g., a WWAN modem), and the inner loop 504 may be implemented in the modem 212—e.g., another modem, such as a WLAN modem. In some cases, the outer loop 502 and inner loop 504 may be implemented in the same modem and/or processor, e.g., the WWAN modem or WLAN modem.

In this example, the outer loop 502 operates as a centralized controller that controls the RF exposure associated with the radios 506. The outer loop 502 may determine the maximum allowed transmit powers that can be used for a future time interval based on the past transmit powers associated with all (or some) of the radios 506 (e.g., the radios 506 that are actively transmitting). For example, the outer loop 502 may periodically (e.g., every 500 milliseconds) receive first information 508 from the inner loop(s) 504 associated with the radios 506. In some cases, the outer loop 502 may obtain the first information 508 in response to certain criteria (e.g., a triggering event including a change in channel conditions, quality of service (QOS), etc.). The periodicity in which the first information 508 is obtained at the outer loop 502 may correspond to a time interval cycle, such as following each future time interval 306, 308 of the rolling time window 302.

The first information 508 may include an indication of a transmit power report and/or an indication of a transmit power request associated with a respective inner loop 504. The indication of the transmit power request may include a requested transmit power or exposure margin for a future time interval (e.g., the time interval 306, 308). The indication of the transmit power report may include past transmit power history or an average transmit power associated with a time interval (e.g., a past time interval in a rolling time window, such as the past time interval 304 or the previous future time interval). A particular inner loop 504 may be associated with one or more radios (e.g., any of the radios 550a-d), and thus, the first information 508 may be associated with such radio(s). As an example, at least one of the inner loops 504 may provide the first information 508 associated with a WLAN radio to the outer loop 502.

The outer loop 502 may determine separate transmit power budgets for the inner loops 504, for example, based on the first information 508 and/or other information (e.g., a particular transmit power budget allocation for an inner loop). In some aspects, the outer loop 502 may determine the transmit power budgets without the first information 508, for example, when an inner loop 504 is not configured to provide the first information 508. The transmit power budgets may be associated with a time interval, such as the future time interval 306, 308, in which to apply the transmit power budgets. The transmit power budgets for the inner loops 504 may comply with an RF exposure limit or any other suitable transmit power control. As an example, the inner loop(s) 504 may obtain the respective transmit power budgets before the future time interval occurs, and the inner loop(s) 504 may determine particular transmit power(s) to use in compliance with the respective transmit power budget(s).

In certain aspects, the outer loop 502 may periodically provide second information 510 to the inner loop(s) 504, where the second information 510 may indicate the transmit power budgets associated with the inner loops 504. In some cases, each of the inner loops 504 may obtain the second information 510, which may indicate a portion of the total transmit power budget for each of the inner loops 504. For example, the outer loop 502 may provide a first transmit power budget to a first inner loop and a second transmit power budget to a second inner loop, where the first transmit power budget and the second transmit power budget are portions of the total transmit power budget distributed among the inner loops 504. In certain cases, a subset of the inner loops 504 may be assigned transmit power budgets, for example, when certain radio(s) are disabled or inactive (e.g., in an idle mode or sleep mode) and not expected to communicate in the respective time interval. In such cases, the outer loop 502 may provide the second information 510 to only the subset of the inner loops 504 that are actively transmitting in the time interval.

For certain aspects, the inner loop 504 may operate in a standalone mode, where the inner loop 504 determines its own transmit power budget in compliance with the RF exposure limit. In standalone mode, the inner loop 504 may determine the transmit power budget without periodic updates from the outer loop 502 and/or other inner loops 504. The inner loop 504 may not communicate with the outer loop 502 while operating in standalone mode. As an example, the inner loop 504 may temporarily stop communications with the outer loop 502 due to the outer loop 502 being in an idle mode or sleep mode, and as such, the inner loop 504 may operate in a standalone mode for purposes of determining RF exposure compliant transmit powers. In some cases, the inner loop 504 may permanently operate in a standalone mode without the updates from the outer loop 502. For example, a WLAN modem and/or a Bluetooth modem may operate in a standalone mode separated from an outer loop and/or inner loop associated with WWAN communications. In such cases of standalone mode, obtaining the transmit power budget may involve the inner loop 504 generating the transmit power budget. In some cases, exposure for one or more RATs (e.g., WWAN) may be managed by a first exposure manager while one or more other RATs (e.g., WLAN, Bluetooth, and/or NTN) are managed by a second exposure manager.

A transmit power budget may indicate the maximum allowed time-averaged transmit power that one or more radio(s) can use for the future time interval in compliance with an RF exposure limit. The maximum allowed time-averaged transmit power may correspond to a portion of a rolling time window (e.g., the future time interval), whereas the maximum time-averaged transmit power (e.g., Pₗᵢₘᵢₜ) may correspond to the entire duration of such a time window associated with the RF exposure limit. A total transmit power budget of a wireless device may be shared among multiple RATs, for example, including WWAN, WLAN, NTN, V2X, D2D, and/or short-range (e.g., Bluetooth) communications. In some cases, the total transmit power budget may be allocated to a single RAT.

The inner loop 504 may determine a transmit power 514 for the future time interval based at least in part on the transmit power budget. As an example, based on the transmit power budget supplied by the outer loop 502 and a current duty cycle, the inner loop 504 may determine the transmit power (P_{TX}) according to the following expression:

$${P}_{TX} = {P}_{limit} + {OL}_{limit} + {P}_{DC} \qquad ( 1 )$$

where Pₗᵢₘᵢₜ may be the maximum time-averaged transmit power limit, corresponding to an RF exposure limit (e.g., a SAR limit or PD limit); OLₗᵢₘᵢₜ is a power adjustment provided by the outer loop (which may positive or negative to increase or decrease Pₗᵢₘᵢₜ); and PDC is the additional power obtained by exploiting low duty cycle. In some cases, Pₗᵢₘᵢₜ may be selected from a look-up table with various transmit power limits corresponding to various transmission scenarios (e.g., any combination of RAT, carrier frequency, frequency band, antenna, antenna group, beam, etc.) and/or exposure scenarios (e.g., head exposure, body-worn exposure, extremity (e.g., hand) exposure, hotspot exposure, etc.).

In certain aspects, the inner loop 504 may determine the transmit power(s) 514 based on other transmit power control(s) 512, such as RF emission controls, RF interference controls, RF conformance control, data rate specific power control, etc., in addition to or instead of the RF exposure controls described herein. In some cases, the transmit power control(s) 512 may provide an additional or alternative transmit power budget and/or limit the maximum transmit power determined, such as to control interference or RF emissions. The transmit power controls 512 may provide one or more maximum allowed transmit powers, and the inner loop 504 may select the smallest value among multiple transmit power levels, including the maximum allowed transmit power for RF compliance, for RF emission controls, RF interference controls, etc. For example, the transmit power for the time interval may be determined according to an expression that selects the smallest value among multiple maximum allowed values as follows:

$${P}_{TX} = min ( {P}_{TX 1} , … , {P}_{TXN} ) \qquad ( 2 )$$

where P_{TX1} through P_{TXN} may represent N number of maximum allowed transmit powers associated various transmit power controls. As an example, at least one of P_{TX1} through P_{TXN} includes the maximum allowed transmit power determined according to the RF exposure controls.

The inner loop 504 may provide an indication of transmit power(s) 514 to the radios 506 and a rate adaptation controller 516 to be used for transmission(s) in the time interval. The indication of the transmit powers 514 may include a maximum allowed transmit power (e.g., the final transmit power to be used) that can be used for the time interval, where the maximum allowed transmit power is in compliance with the RF exposure limit according to the transmit power budget and/or the transmit power controls 512.

The rate adaptation controller 516 may obtain the indication of the transmit powers 514 and determine one or more transfer rate configurations based at least in part on the transmit powers 514. The rate adaptation controller 516 may be implemented via a processor and/or memory, such as the processor 210, the modem 212, and the memory 240. The rate adaptation controller 516 may determine the transfer rate configurations in response to a change in the transmit powers 514, for example. The rate adaptation controller 516 may select a particular transfer rate configuration among a plurality of configurations based on the transmit powers 514 and/or a parameter associated with (affected by) the transmit powers 514. The rate adaptation controller 516 may be an example of the RA manager 106.

A change in the transmit power(s) 514 may be caused due to any of various reasons. For example, a modem transitioning to a different state (e.g., a modem coming out of a sleep mode or going into the sleep mode) may cause a change in transmit power as the transmit power budget is redistributed among the radios. In some cases, a particular radio (e.g., a WWAN radio) may be allocated a greater portion of the transmit power budget, such that a radio that uses rate adaptation may be allocated a smaller portion of the transmit power budget. Such a change in the transmit power budget distribution may cause a change in the transmit power. A transmit power change may also be due to a change in transmission duty cycle, a change in mobility state of the wireless device, and/or a change in channel conditions (e.g., transmission range, path loss, signal strength, signal quality, etc.).

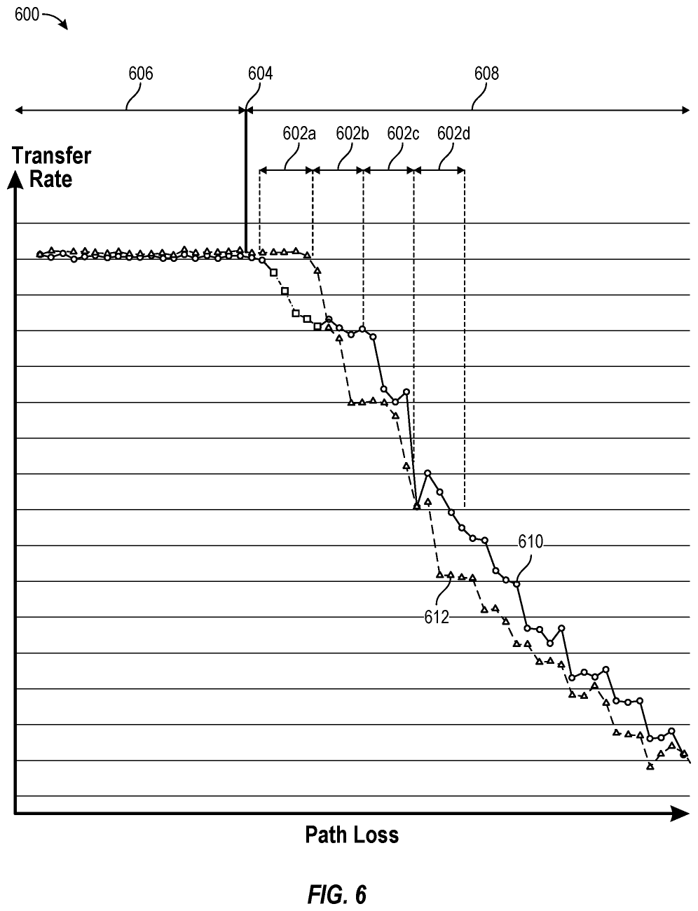

FIG. 6 is a graph 600 of transfer rates over path loss levels illustrating example transfer rate regions 602a-d. As shown, the graph 600 provides a first transfer rate curve 610 and a second transfer rate curve 612. The first transfer rate curve is representative of the transfer rates over path loss levels when a first RF exposure compliance technique is applied (e.g., a time-averaging RF exposure evaluation), whereas the second transfer rate curve 612 is representative of the transfer rates over path loss levels when a second RF exposure compliance technique is applied (e.g., a peak transmit power limit is used without time-averaging).

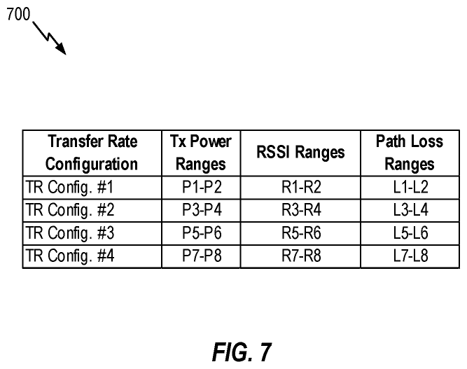

In this example, the transfer rate regions 602a-d may represent a relationship between transfer rates and certain states associated with the channel conditions. For example, the first transfer rate region 602a may correspond to a first range of signal strengths (e.g., RSSI) and a first transfer rate (or a configuration thereof); the second transfer rate region 602b may correspond to a second range of signal strengths and a second transfer rate; and so on for the third transfer rate region 602c and the fourth transfer rate region 602d. The transfer rate regions 602a-d and corresponding transfer rates may be determined through testing, simulations, and/or calibration. For example, a sample wireless device may undergo testing or simulations to determine the transfer rate regions 602a-d associated with various transmission scenarios (e.g., frequency band, antenna, channel conditions, signal quality, signal strength, transmit power, etc.). As a result of the testing and/or simulations, mass-production wireless devices may be pre-programmed with transfer rate configurations (e.g., corresponding to the transfer rate regions 602a-d) mapped to various channel conditions, for example, as further described herein with respect to FIG. 7. In some cases, the wireless device may perform online calibration to determine and/or update the mapping between transfer rate configurations and various channel conditions.

In some cases, the transfer rate regions 602a-d may be determined based on rate sensitivities provided by a wireless communication standard (e.g., IEEE 802.11 standards or any suitable wireless communication standard). In response to the transmit power causing or being predicted to cause a transition among transfer rate sensitivities, the wireless device may select a transfer rate corresponding to the transfer rate sensitivity and transmit power. As an example, if the transmit power falls below the MCS9 lower bound, the rate adaptation controller may select MCS8 for transmissions. It will be appreciated that the transfer rate regions 602a-d are example regions, and a wireless device may be configured with any number of transfer rate regions in addition to or instead of the transfer rate regions 602a-d. The transfer rate regions 602a-d may correspond to a particular radio, antenna, frequency channel (band, carrier, bandwidth, etc.), RAT, and/or generation of a RAT. For example, the wireless device may have transfer rate regions for each generation of a RAT, such as 802.11a, 802.11b, 802.11g. 802.11n, 802.11ac, 802.11ax, 802.11be, and/or any other future generation.

The rate adaptation controller 516 may select a transfer rate (or a configuration thereof) among the transfer rate regions 602a-d based at least in part on the transmit power(s) 514, for example as obtained from the inner loop 504. In certain cases, the rate adaptation controller 516 may estimate the received signal strength at the other wireless device (e.g., the second wireless device 104) as being equivalent to the signal strength of signals received from the other wireless device and measured at the wireless device. In such cases, the rate adaptation controller 516 may select the transfer rate among the transfer rate regions 602a-d in response to a change in the transmit power(s).

Suppose, for example, the wireless device is transmitting at a transfer rate corresponding to the second transfer rate region 602b. In response to a decrease in the transmit power, the rate adaptation controller 516 may select a lower transfer rate (e.g., the transfer rate corresponding to the third transfer rate region 602c) as the signal strength at the receiving entity may decrease and support lower throughput. In response to an increase in the transmit power, the rate adaptation controller 516 may select a higher transfer rate (e.g., the transfer rate corresponding to the first transfer rate region 602a) as the signal strength at the receiving entity may increase and facilitate higher throughput.

In some cases, the rate adaptation controller 516 may estimate the received signal strength at the other wireless device (e.g., the second wireless device 104) based on the transmit power and the path loss associated with the communication link between the wireless device and the other wireless device. In certain aspects, the rate adaptation controller 516 may determine the received signal strength (P_{RX})—for example, RSSI—according to the following expression:

$${P}_{RX} = {P}_{TX} - pathloss \qquad ( 3 )$$

where P_{TX} may include any of the transmit power(s) obtained from the inner loop 504, and pathloss may be the path loss between the wireless device and the receiving entity. In some cases, the path loss may be determined assuming channel reciprocity between the wireless device and the other wireless device. For example, the wireless device may determine the path loss as a difference of a transmit power used at the other wireless device and a received signal strength at the wireless device. The transmit power used at the other wireless device may be assumed to be a particular value or provided to the wireless device. In some cases, the wireless device may obtain an explicit indication of the path loss from the other wireless device.

In certain aspects, the rate adaptation controller 516 may select the transfer rate (or a configuration thereof) based at least in part on the transmit power in response to one or more criteria being satisfied. For example, the rate adaptation controller 516 may determine the transfer rate (or a configuration thereof) based on channel conditions (e.g., SNR, RSSI, path loss, PER, etc.) without the transmit powers if certain channel condition(s) satisfy a threshold 604 (e.g., if the RSSI is greater than a threshold and/or if the path loss less than a threshold). As shown, in a first region 606, the rate adaptation controller 516 may determine the transfer rate without the transmit powers as the channel conditions (e.g., a low path loss, a short transmission range, etc.) may allow for variations in transmit power without affecting the transfer rate or with minor effects. In a second region 608, the rate adaptation controller 516 may determine the transfer rate based at least in part on the transmit power(s) 514 obtained from the inner loop 504 as described herein. As an example, the threshold 604 may be a value of any suitable parameter associated with the channel conditions, for example, including SNR, SINR, RSSI, RSRQ, and/or PER. In certain aspects, the threshold 604 may be or include a configurable value. Each of the first region 606 and the second region 608 may correspond to a particular state of the channel conditions. For example, the first region 606 may correspond to when channel condition(s) satisfy the threshold 604, and the second region 608 may correspond to when the channel condition(s) do not satisfy the threshold 604.

In the second region 608, the rate adaptation controller 516 may consider or take into account the transmit power(s) 514 obtained from the inner loop 504 in determining the transfer rate. The transmit power(s) 514 may enable the rate adaptation controller 516 to anticipate a change in channel conditions due to a change in transmit power. The transmit-power-aware rate adaptation may enable an efficient transfer rate convergence on the communication link between the wireless device and the other wireless device. The transmit-power-aware rate adaptation may improve wireless communications on the communication link, for example, including an increased throughput, reduced latency, and/or reduced retransmissions.

FIG. 7 depicts an example table 700 mapping transfer rate configurations to various channel conditions, including, transmit power ranges, RSSI ranges, and path loss ranges. In this example, a first transfer rate configuration (TR Config. #1) may map to a first range of transmit powers (e.g., P1-P2), a first range of RSSIs (e.g., R1-R2), and/or a first range of path loss levels (e.g., L1-L2). The second transfer rate configuration (TR Config. #2) may map to a second range of transmit powers (e.g., P3-P4), a second range of RSSIs (e.g., R3-R4), and/or a second range of path loss levels (e.g., L3-L4); and so on for the third transfer rate configuration and the fourth transfer rate configuration. The transfer rate regions depicted in FIG. 6 may correspond to the ranges of channel conditions depicted in the table 700, which may be pre-programmed in a wireless device as derived from testing and/or simulations and/or determined or updated during online operations of the wireless device.

A transfer rate configuration may correspond to one or more parameters associated with a transfer rate, where the parameter(s) may include, for example, the number of spatial streams in a transmission, an MCS, a code rate, a guard interval, and/or a channel width. The wireless device may use the table to select a transfer rate configuration corresponding to the channel conditions encountered by the wireless device. Suppose, for example, the transmit power obtained at the rate adaptation controller 516 indicates the RSSI at the receiving entity (e.g., the second wireless device 104) may be in the RSS range of R5 through R6, the rate adaptation controller 516 may select the third transfer rate configuration for the transmission. The transfer rate configurations depicted and corresponding channel conditions are examples, and a wireless device may be configured with any number of transfer rate configurations and/or corresponding channel conditions.

While the examples depicted in FIGS. 6 and 7 are described herein with respect to mapping transfer rates (or configurations thereof) to transmit powers, RSSIs, and/or levels of path loss to facilitate understanding, aspects of the present disclosure may also be applied to determining a transfer rate (or a configuration thereof) based on any other suitable parameters, such as parameter(s) indicative of channel conditions including data error rate or ratio, SNR, SINR, etc.

Some or all of the parameters and/or values depicted in table 700 may be configured in or stored on a wireless device, for example, in the memory 240. In some cases, the transmit power may be used to determine an RSSI based on the pathloss, for example, according to Expression (3). Thus, the wireless device may use a predicted RSSI (determined based on the transmit power and pathloss) that maps to a transfer rate configuration using the mapping between RSSI and the transfer rate configuration in the table 700. The transmit power ranges may not be stored in the respective table on the wireless device. In certain cases, certain transmit powers and/or RSSIs may be associated with a particular range of path losses (corresponding to a particular transfer rate region 602). Thus, the transmit powers and/or RSSIs may be mapped to transfer rate configurations in a table stored on the wireless device, and the ranges of pathlosses may not be stored on the wireless device after determining the correlation between the transmit powers and the path losses. Other values may also be added to or omitted from the table 700 in various examples.

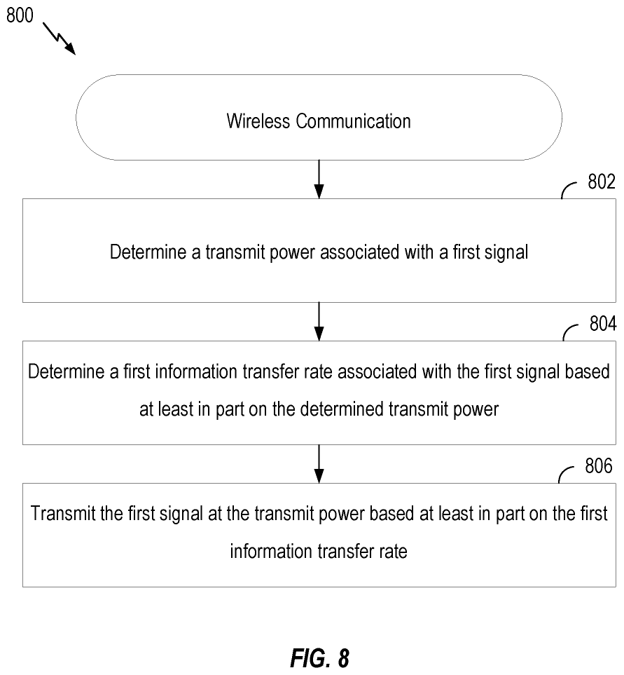

FIG. 8 is a flow diagram illustrating example operations 800 for wireless communication. The operations 800 may be performed, for example, by a wireless device (e.g., the first wireless device 102 in the wireless communication system 100). The operations 800 may be implemented as software components that are executed and run on one or more processors (e.g., the processor 210 and/or the modem 212 of FIG. 2). Further, the transmission and/or reception of signals by the wireless device in the operations 800 may be enabled, for example, by one or more antennas (e.g., antennas 218 of FIG. 2). In certain aspects, the transmission and/or reception of signals by the wireless device may be implemented via a bus interface of one or more processors (e.g., the processor 210 and/or the modem 212) obtaining and/or outputting signals for reception or transmission.

The operations 800 may optionally begin, at block 802, where the wireless device may determine a transmit power (e.g., the transmit powers 514) associated with a first signal. The wireless device may determine the transmit power via an RF exposure evaluation and/or any other suitable transmit power control, for example, as described herein with respect to FIG. 5. As an example, the wireless device may periodically determine a transmit power associated with a transmission in a time interval (e.g., the time interval 306) as described herein with respect to FIG. 5.

At block 804, the wireless device may determine a first information transfer rate (or a configuration thereof) associated with the first signal based at least in part on the determined transmit power. For example, the wireless device may perform transmit-power-aware rate adaptation as described herein. The wireless device may determine the first information transfer rate using a table (e.g., the table 700) that maps transfer rate configurations to various channel conditions, including the transmit power or conditions derived therefrom. For example, the wireless device may select a transfer rate corresponding to the channel conditions encountered at the wireless device, where the channel conditions may be determined based at least in part on the transmit power. An information transfer rate may refer to a transfer rate for information (e.g., a data rate or throughput) between the wireless device and another wireless device (e.g., the second wireless device 104).

In certain aspects, the transmit power may facilitate the wireless device to predict the value(s) of certain parameter(s) related to the channel conditions (such as a received signal strength and/or signal quality at a receiving entity, for example, the second wireless device 104) associated with a future transmission, and the wireless device may adjust the transfer rate (or a configuration thereof) for the future transmission in response to detecting a change in the predicted value(s). For example, the wireless device may predict the received signal strength (will increase or decrease) based on a model of the channel conditions and the transmit power, for example, according to Expression (3), and the wireless device may select the transfer rate based on the predicted received signal strength for a future transmission. The transmit-power-aware rate adaptation described herein may allow a wireless device to anticipate changes in a communication link that can affect the transfer rate based on the transmit power, and thus, the wireless device may inform a rate adaptation controller of the transmit power to improve the transfer rate selection and provide information that can predict the communication link performance for future transmission(s). Therefore, the transmit-power-aware rate adaptation described herein may allow the wireless device to perform rate adaptation in a forward looking manner (e.g., using the transmit power for a future transmission) in addition to or instead of a reactionary manner dependent on past communication link performance link (e.g., using metric(s) associated with past link performance, such as RSSI, pathloss, data error rate, rata error ratio, etc.).

At block 806, the wireless device may transmit the first signal at the transmit power based at least in part on the first information transfer rate. For example, the wireless device may transmit the first signal to a second wireless communication device (e.g., any of the second wireless devices 104 depicted in FIG. 1). The first signal may indicate (or carry) any of various information, such as data or control information. In some cases, the first signal may indicate (or carry) one or more packets or data blocks. In certain cases, the wireless device may transmit the first signal via a WLAN RAT or any other RAT that performs rate adaptation.

In certain aspects, to determine the transmit power, the wireless device may perform an RF exposure evaluation, for example, as described herein with respect to FIG. 5. To determine the transmit power, the wireless device may determine the transmit power based at least in part on an RF exposure limit, for example, as described herein with respect to FIGS. 3 and 5. In some cases, the RF exposure limit may include a time-averaged RF exposure limit. To determine the transmit power, the wireless device may determine a time-averaged transmit power for one or more transmissions over a time window (e.g., the time window 302). The one or more transmissions may include at least a portion of the first signal being transmitted at the transmit power. The wireless device may determine the time-averaged transmit power is less than or equal to a maximum time-averaged transmit power (e.g., Pₗᵢₘᵢₜ) corresponding to the RF exposure limit.

To determine the first information transfer rate, the wireless device may determine the first information transfer rate in response to detecting a change in a maximum allowed transmit power. In some cases, the wireless device may determine the transmit power at block 802 based on a maximum allowed transmit power, for example, as described herein with respect to FIG. 5. For example, the wireless device may determine the transmit power at block 802 to be less than or equal to a maximum allowed transmit power associated with a time interval. The maximum allowed transmit power may correspond to the transmit power associated with the transmit power budget or the transmit power(s) 514 provided to the rate adaptation controller 516. A change in the maximum allowed transmit power may occur due to a transition of a modem from being inactive in a sleep mode to being active or vice versa, for example.

For certain aspects, to determine the first information transfer rate, the wireless device may determine the first information transfer rate in response to detecting a change in state associated with a particular component, such as a radio (e.g., the radio 250) and/or a modem (e.g., the modem 212) of the wireless device. For example, a particular modem may awake from a sleep mode or transition to the sleep mode, and such an event may trigger a change to the transmit power budget allocated to the radio(s) associated with that modem.

In certain aspects, the transfer rate may correspond to one or more parameters that facilitate the transfer rate. To determine the first information transfer rate, the wireless device may determine one or more parameters associated with the first information transfer rate. To transmit the first signal, the wireless device may transmit the first signal based on the one or more parameters associated with the first information transfer rate. In some cases, the parameter(s) associated with the first information transfer rate may include a number of spatial streams, an MCS, a code rate, a guard interval, a channel width, or a combination thereof. The number of spatial streams may represent the number of separate data streams that can be transmitted simultaneously. The MCS may include, for example, binary phase-shift keying (BPSK), quadrature phase-shift keying (QPSK), and/or levels of quadrature amplitude modulation (QAM). The code rate may represent the proportion of a data-stream that is non-redundant. The guard interval may be an interval of time in which wireless device(s) refrain from transmitting to mitigate interference. The channel width may be the bandwidth of a channel in a frequency band, for example, as provided in the IEEE 802.11 standards.

For certain aspects, the wireless device may determine the information transfer rate via a table (e.g., the table 700) and/or any other suitable data structure. To determine the first information transfer rate, the wireless device may determine the first information transfer rate based on a table (e.g., the table 700) mapping a plurality of transfer rates (or configurations thereof) to transmit powers or mapping the plurality of transfer rates to values of a parameter associated with the transmit power. The wireless device may select the first information transfer rate among the plurality of transfer rates mapped to ranges of the transmit powers (e.g., a range of P1-P2 as depicted in FIG. 7), including the transmit power, or mapped to ranges of the values of the parameter (e.g., a range of R1-R2 as depicted in FIG. 7). The parameter may include a path loss associated with the first signal, a signal strength (e.g., RSSI) associated with the first signal, a signal quality (e.g., SNR) associated with the first signal, or a combination thereof.

The wireless device may determine a (predicted) value (e.g., R1) of the parameter based at least in part on the transmit power (e.g., P1). As an example, the wireless device may determine a predicted value of the received signal strength based on the transmit power and a known or estimated pathloss between the wireless device and another wireless device (e.g., the second wireless device 104), for example, according to Expression (3). The wireless device may identify the value is in one of the ranges of the values (e.g., R1-R2). The wireless device may identify the first information transfer rate corresponds to the respective range, for example, the first transfer rate configuration corresponds to the range of R1-R2. As an example, the wireless device may determine a received signal strength based on the transmit power determined at block 802 and a path loss associated with a communication link between the wireless device and another wireless device (e.g., the second wireless device 104), for example, as described herein with respect to Expression (3). The wireless device may determine the first information transfer rate that maps to the range of signal strengths, which includes the received signal strength as determined with the transmit power.

In some cases, the wireless devices may determine the first information transfer rate based at least in part on the determined transmit power in response to determining one or more first criteria are satisfied, for example, as described herein with respect to FIG. 6. The one or more criteria may include any of various criterion associated with channel conditions, for example, including a first criterion associated with a signal quality, a second criterion associated with a path loss, a third criterion associated with a data error rate (e.g., a packet or frame error rate), a fourth criterion associated with a data error ratio (e.g., packet or frame error ratio), or any combination thereof. In certain cases, the one or more criteria may be satisfied when a signal quality (and/or signal strength) associated with one or more transmissions is less than or equal to a threshold (e.g., the threshold 604). For certain aspects, the threshold may be configurable. In some cases, the one or more criteria may be satisfied when a path loss associated with one or more transmissions is more than or equal to a threshold.

In certain aspects, the wireless device may determine the transfer rate without the transmit power(s) obtained from the inner loop in response to one or more second criteria being satisfied, for example, as described herein with respect to FIG. 6. The wireless device may determine a second information transfer rate associated with a second signal in response to determining one or more criteria are satisfied, and the wireless device may transmit the second signal based at least in part on the second information transfer rate. In some cases, the wireless device may determine the second information transfer rate without any transmit power information, for example, without the transmit powers obtained from the inner loop as described herein with respect to FIG. 5. The wireless device may determine the second information transfer rate based at least in part on one or more parameters including a signal quality, a signal strength, a path loss, a data error rate, data error ratio, or any combination thereof. In some cases, the one or more criteria may be satisfied when a signal quality (and/or signal strength) associated with one or more transmissions is greater than a threshold (e.g., the threshold 604). In certain cases, the one or more criteria may be satisfied when a path loss associated with one or more transmissions is less than a threshold.

Aspects of the present disclosure may be applied to any of various wireless communication devices (wireless devices) that may perform rate adaptation, such as a base station, access point, and/or a CPE, performing the rate adaptation described herein.

### Example Communications Device

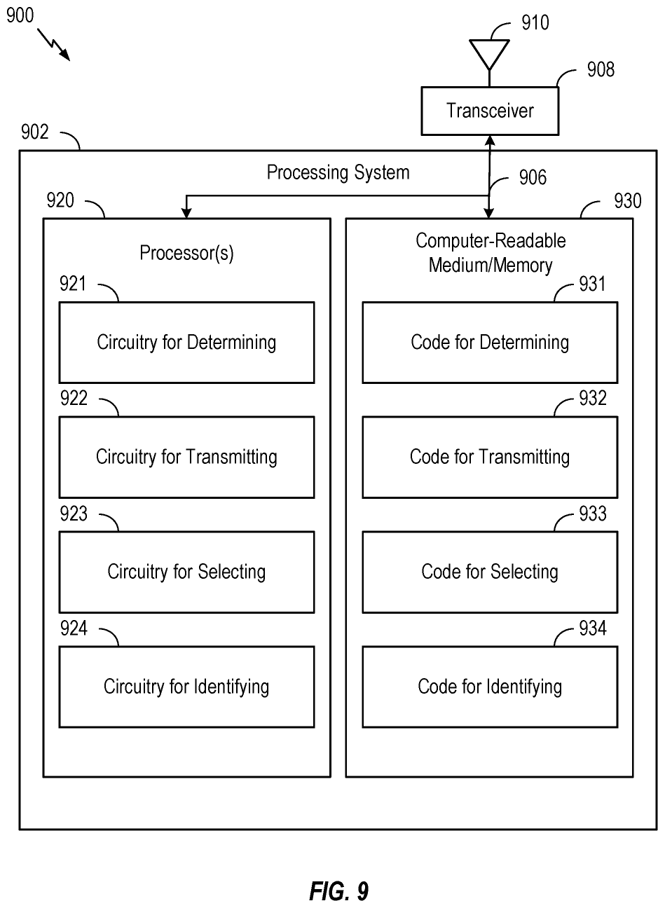

FIG. 9 depicts aspects of an example communications device 900. In some aspects, communications device 900 is a wireless communication device, such as the first wireless device 102 described above with respect to FIGS. 1 and 2.

The communications device 900 includes a processing system 902 coupled to a transceiver 908 (e.g., a transmitter and/or a receiver). The transceiver 908 is configured to transmit and receive signals for the communications device 900 via an antenna 910, such as the various signals as described herein. The processing system 902 may be configured to perform processing functions for the communications device 900, including processing signals received and/or to be transmitted by the communications device 900.

The processing system 902 includes one or more processors 920. In various aspects, the one or more processors 920 may be representative of any of the processor 210 and/or the modem 212, as described with respect to FIG. 2. The one or more processors 920 are coupled to a computer-readable medium/memory 930 via a bus 906. In certain aspects, the computer-readable medium/memory 930 is configured to store instructions (e.g., computer-executable code) that when executed by the one or more processors 920, cause the one or more processors 920 to perform the operations 800 described with respect to FIG. 8, or any aspect related to the operations described herein. Note that reference to a processor performing a function of communications device 900 may include one or more processors performing that function of communications device 900. Reference to one or more processors performing multiple functions may include any one of the one or more processors performing any one of the multiple functions.

In the depicted example, computer-readable medium/memory 930 stores code (e.g., executable instructions) for determining 931, code for transmitting 932, code for selecting 933, code for identifying 934, or any combination thereof. Processing of the code 931-934 may cause the communications device 900 to perform the operations 800 described with respect to FIG. 8, or any aspect related to operations described herein.

The one or more processors 920 include circuitry configured to implement (e.g., execute) the code stored in the computer-readable medium/memory 930, including circuitry for determining 921, circuitry for transmitting 922, circuitry for selecting 923, circuitry for identifying 924, or any combination thereof. Processing with circuitry 921-924 may cause the communications device 900 to perform the operations 800 described with respect to FIG. 8, or any aspect related to operations described herein.

Various components of the communications device 900 may provide means for performing the operations 800 described with respect to FIG. 8, or any aspect related to operations described herein. For example, means for transmitting, sending or outputting for transmission may include the TX path 214 and/or antenna(s) 218 of the first wireless device 102 illustrated in FIG. 2 and/or transceiver 908 and antenna 910 of the communications device 900 in FIG. 9. Means for receiving or obtaining may include the RX path 216 and/or antenna(s) 218 of the first wireless device illustrated in FIG. 2 and/or transceiver 908 and antenna 910 of the communications device 900 in FIG. 9. Means for determining, means for selecting, and/or means for identifying may include one or more processors, such as the processor 210 and/or modem 212 depicted in FIG. 2 and/or the processor(s) 920 in FIG. 9.

### Example Aspects

Implementation examples are described in the following numbered clauses:

Aspect 1: A method of wireless communication by a wireless device, comprising: determining a transmit power associated with a first signal; determining a first information transfer rate associated with the first signal based at least in part on the determined transmit power; and transmitting the first signal at the transmit power based at least in part on the first information transfer rate.

Aspect 2: The method of Aspect 1, wherein determining the transmit power comprises determining the transmit power based at least in part on a radio frequency (RF) exposure limit.

Aspect 3: The method of Aspect 2, wherein the RF exposure limit comprises a time-averaged RF exposure limit.

Aspect 4: The method of Aspect 2 or 3, wherein determining the transmit power comprises: determining a time-averaged transmit power for one or more transmissions over a time window, wherein the one or more transmissions include at least a portion of the first signal being transmitted at the transmit power; and determining the time-averaged transmit power is less than or equal to a maximum time-averaged transmit power corresponding to the RF exposure limit.

Aspect 5: The method according to any of Aspects 1-4, wherein determining the first information transfer rate comprises determining the first information transfer rate in response to detecting a change in a maximum allowed transmit power.

Aspect 6: The method according to any of Aspects 1-5, wherein determining the first information transfer rate comprises determining the first information transfer rate in response to detecting a change in state associated with a radio.

Aspect 7: The method according to any of Aspects 1-6, wherein: determining the first information transfer rate comprises determining one or more parameters associated with the first information transfer rate; and transmitting the first signal comprises transmitting the first signal based on the one or more parameters associated with the first information transfer rate.

Aspect 8: The method of Aspect 7, wherein the one or more parameters associated with the first information transfer rate comprise a modulation and coding scheme (MCS), a code rate, a guard interval, a channel width, or a combination thereof.

Aspect 9: The method according to any of Aspects 1-8, wherein determining the first information transfer rate comprises determining the first information transfer rate based on a table mapping a plurality of transfer rates to transmit powers or mapping the plurality of transfer rates to values of a parameter associated with the transmit power.

Aspect 10: The method of Aspect 9, wherein determining the first information transfer rate comprises selecting the first information transfer rate among the plurality of transfer rates mapped to ranges of the transmit powers, including the transmit power, or mapped to ranges of the values of the parameter.

Aspect 11: The method of Aspect 10, wherein the parameter includes a path loss associated with the first signal, a signal quality associated with the first signal, or a combination thereof.

Aspect 12: The method of Aspect 10 or 11, wherein determining the first information transfer rate further comprises: determining a predicted value of the parameter based at least in part on the transmit power; identifying the value is in one of the ranges of the values; and identifying the first information transfer rate corresponding to the respective range.

Aspect 13: The method according to any of Aspects 1-12, wherein determining the first information transfer rate comprises determining the first information transfer rate based at least in part on the determined transmit power in response to determining one or more criteria are satisfied.

Aspect 14: The method of Aspect 13, wherein the one or more criteria comprise: a first criterion associated with a signal quality, a second criterion associated with a path loss, a third criterion associated with a data error rate, a fourth criterion associated with a data error ratio, or any combination thereof.

Aspect 15: The method of Aspect 13 or 14, wherein the one or more criteria are satisfied when a signal quality associated with one or more transmissions is less than or equal to a threshold.

Aspect 16: The method of Aspect 15, wherein the threshold is configurable.

Aspect 17: The method according to any of Aspects 13-16, wherein the one or more criteria are satisfied when a path loss associated with one or more transmissions is more than or equal to a threshold.

Aspect 18: The method according to any of Aspects 1-17, further comprising: determining a second information transfer rate associated with a second signal in response to determining one or more criteria are satisfied; and transmitting the second signal based at least in part on the second information transfer rate.

Aspect 19: The method of Aspect 18, wherein determining the second information transfer rate comprises determining the second information transfer rate based at least in part on one or more parameters including a signal quality, a path loss, a data error rate, data error ratio, or any combination thereof.

Aspect 20: The method of Aspect 18 or 19, wherein the one or more criteria are satisfied when a signal quality associated with one or more transmissions is greater than a threshold.

Aspect 21: The method according to any of Aspects 18-20, wherein the one or more criteria are satisfied when a path loss associated with one or more transmissions is less than a threshold.

Aspect 22: The method according to any of Aspects 1-21, wherein transmitting the first signal comprises transmitting the first signal via a wireless local area network (WLAN) radio access technology.

Aspect 23: An apparatus for wireless communication, comprising: a memory; and one or more processors coupled to the memory, the one or more processors being configured to: determine a transmit power associated with a first signal, determine a first information transfer rate associated with the first signal based at least in part on the determined transmit power, and control transmission of the first signal at the transmit power based at least in part on the first information transfer rate.

Aspect 24: The apparatus of Aspect 23, further comprising one or more transmitters coupled to the one or more processors, the one or more transmitters being configured to transmit the first signal at the transmit power, wherein to determine the transmit power, the one or more processors being further configured to determine the transmit power based at least in part on a radio frequency (RF) exposure limit.

Aspect 25: The apparatus of Aspect 23 or 24, wherein to determine the first information transfer rate, the one or more processors are further configured to determine the first information transfer rate in response to detecting a change in a maximum allowed transmit power.

Aspect 26: The apparatus according to any of Aspects 23-25, wherein to determine the first information transfer rate, the one or more processor are further configured to determine the first information transfer rate in response to detecting a change in state associated with a radio.

Aspect 27: The apparatus according to any of Aspects 23-26, wherein the one or more processors are further configured to: determine one or more parameters associated with the first information transfer rate, and control transmission of the first signal based on the one or more parameters associated with the first information transfer rate.

Aspect 28: The apparatus according to any of Aspects 23-27, wherein to determine the first information transfer rate, the one or more processors are further configured to determine the first information transfer rate based on a table mapping a plurality of transfer rates to transmit powers or mapping the plurality of transfer rates to values of a parameter associated with the transmit power.

Aspect 29: The apparatus according to any of Aspects 23-28, wherein to determine the first information transfer rate, the one or more processors are further configured to determine the first information transfer rate based at least in part on the determined transmit power in response to determining one or more criteria are satisfied.

Aspect 30: The apparatus according to any of Aspects 23-29, wherein the one or more processors are further configured to: determine a second information transfer rate associated with a second signal in response to determining one or more criteria are satisfied, and control transmission of the second signal based at least in part on the second information transfer rate.

Aspect 31: An apparatus, comprising: a memory comprising computer-executable instructions; and one or more processors configured to execute the computer-executable instructions and cause the apparatus to perform a method in accordance with any of Aspects 1-22.

Aspect 32: An apparatus, comprising means for performing a method in accordance with any of Aspects 1-22.

Aspect 33: A non-transitory computer-readable medium comprising computer-executable instructions that, when executed by one or more processors of a processing system, cause the processing system to perform a method in accordance with any of Aspects 1-22.

Aspect 34: A computer program product embodied on a computer-readable storage medium comprising code for performing a method in accordance with any of Aspects 1-22.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a microcontroller, a microprocessor, a general-purpose processor, a digital signal processor (DSP), a neural network processor, an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory), and the like. Also, “determining” may include resolving, selecting, identifying, mapping, applying, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” The use of a definite article (e.g., “the” or “said”) before an element is not intended to impart a singular meaning (e.g., “one and only one”) on an otherwise plural meaning (e.g., “one or more”) associated with the element unless specifically so stated. Unless specifically stated otherwise, the term “some” refers to one or more. No claim element is to be construed under the provisions of 35 U.S.C. § 112(f) unless the element is expressly recited using the phrase “means for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method of wireless communication by a wireless device, comprising:
determining a transmit power associated with a first signal;
determining a first information transfer rate associated with the first signal based at least in part on the determined transmit power; and
transmitting the first signal at the transmit power based at least in part on the first information transfer rate.

2. The method of claim 1, wherein determining the transmit power comprises determining the transmit power based at least in part on a radio frequency (RF) exposure limit.

3. The method of claim 2, wherein the RF exposure limit comprises a time-averaged RF exposure limit.

4. The method of claim 2, wherein determining the transmit power comprises:
determining a time-averaged transmit power for one or more transmissions over a time window, wherein the one or more transmissions include at least a portion of the first signal being transmitted at the transmit power; and
determining the time-averaged transmit power is less than or equal to a maximum time-averaged transmit power corresponding to the RF exposure limit.

5. The method of claim 1, wherein determining the first information transfer rate comprises determining the first information transfer rate in response to detecting a change in a maximum allowed transmit power.

6. The method of claim 1, wherein determining the first information transfer rate comprises determining the first information transfer rate in response to detecting a change in state associated with a radio.

7. The method of claim 1, wherein:
determining the first information transfer rate comprises determining one or more parameters associated with the first information transfer rate; and
transmitting the first signal comprises transmitting the first signal based on the one or more parameters associated with the first information transfer rate.

8. The method of claim 7, wherein the one or more parameters associated with the first information transfer rate comprise a modulation and coding scheme (MCS), a code rate, a guard interval, a channel width, or a combination thereof.

9. The method of claim 1, wherein determining the first information transfer rate comprises determining the first information transfer rate based on a table mapping a plurality of transfer rates to transmit powers or mapping the plurality of transfer rates to values of a parameter associated with the transmit power.

10. The method of claim 9, wherein determining the first information transfer rate comprises selecting the first information transfer rate among the plurality of transfer rates mapped to ranges of the transmit powers, including the transmit power, or mapped to ranges of the values of the parameter.

11. The method of claim 10, wherein the parameter includes a path loss associated with the first signal, a signal quality associated with the first signal, or a combination thereof.

12. The method of claim 10, wherein determining the first information transfer rate further comprises:
determining a predicted value of the parameter based at least in part on the transmit power;
identifying the predicted value is in one of the ranges of the values; and
identifying the first information transfer rate corresponding to the respective range.

13. The method of claim 1, wherein determining the first information transfer rate comprises determining the first information transfer rate based at least in part on the determined transmit power in response to determining one or more criteria are satisfied.

14. The method of claim 13, wherein the one or more criteria comprise:
a first criterion associated with a signal quality,
a second criterion associated with a path loss,
a third criterion associated with a data error rate,
a fourth criterion associated with a data error ratio, or
any combination thereof.

15. The method of claim 13, wherein the one or more criteria are satisfied when a signal quality associated with one or more transmissions is less than or equal to a threshold.

16. The method of claim 15, wherein the threshold is configurable.

17. The method of claim 13, wherein the one or more criteria are satisfied when a path loss associated with one or more transmissions is more than or equal to a threshold.

18. The method of claim 1, further comprising:
determining a second information transfer rate associated with a second signal in response to determining one or more criteria are satisfied; and
transmitting the second signal based at least in part on the second information transfer rate.

19. The method of claim 18, wherein determining the second information transfer rate comprises determining the second information transfer rate based at least in part on one or more parameters including a signal quality, a path loss, a data error rate, data error ratio, or any combination thereof.

20. The method of claim 18, wherein the one or more criteria are satisfied when a signal quality associated with one or more transmissions is greater than a threshold.

21. The method of claim 18, wherein the one or more criteria are satisfied when a path loss associated with one or more transmissions is less than a threshold.

22. The method of claim 1, wherein transmitting the first signal comprises transmitting the first signal via a wireless local area network (WLAN) radio access technology.

23. An apparatus for wireless communication, comprising:
a memory; and
one or more processors coupled to the memory, the one or more processors being configured to:
determine a transmit power associated with a first signal,
determine a first information transfer rate associated with the first signal based at least in part on the determined transmit power, and
control transmission of the first signal at the transmit power based at least in part on the first information transfer rate.

24. The apparatus of claim 23, further comprising one or more transmitters coupled to the one or more processors, the one or more transmitters being configured to transmit the first signal at the transmit power, wherein to determine the transmit power, the one or more processors are further configured to determine the transmit power based at least in part on a radio frequency (RF) exposure limit.

25. The apparatus of claim 23, wherein to determine the first information transfer rate, the one or more processors are further configured to determine the first information transfer rate in response to detecting a change in a maximum allowed transmit power.

26. The apparatus of claim 23, wherein to determine the first information transfer rate, the one or more processors are further configured to determine the first information transfer rate in response to detecting a change in state associated with a radio.

27. The apparatus of claim 23, wherein the one or more processors are further configured to:
determine one or more parameters associated with the first information transfer rate, and
control transmission of the first signal based on the one or more parameters associated with the first information transfer rate.

28. The apparatus of claim 23, wherein to determine the first information transfer rate, the one or more processors are further configured to determine the first information transfer rate based on a table mapping a plurality of transfer rates to transmit powers or mapping the plurality of transfer rates to values of a parameter associated with the transmit power.

29. The apparatus of claim 23, wherein to determine the first information transfer rate, the one or more processors are further configured to determine the first information transfer rate based at least in part on the determined transmit power in response to determining one or more criteria are satisfied.

30. The apparatus of claim 23, wherein the one or more processors are further configured to:
determine a second information transfer rate associated with a second signal in response to determining one or more criteria are satisfied, and
control transmission of the second signal based at least in part on the second information transfer rate.
